(19) United States
(12) Patent Application Publication
(10) Pub. No.: US 2026/0088915 A1
(43) Pub. Date: Mar. 26, 2026

(54) MEASUREMENT OF RADIO-FREQUENCY SIGNAL PROPAGATION CONDITIONS

(71) Applicant: GM Global Technology Operations LLC, Detroit, MI (US)

(72) Inventor: Igal Kotzer, Tel-Aviv (IL)

(21) Appl. No.: 18/894,560

(22) Filed: Sep. 24, 2024

(51) Int. Cl. H04B 17/00; H04B 17/391; H04W 64/00

(52) U.S. Cl. CPC H04B 17/0087; H04B 17/3912; H04W 64/003

(57) ABSTRACT

A method for determining cellular signal characteristics includes receiving and recording a plurality of cellular signal data at one of a plurality of locations in an environment. The method further may include identifying one or more individual cellular signals received at the one of the plurality of locations based at least in part on the plurality of cellular signal data. The method further may include determining one or more cellular signal characteristics of each of the one or more individual cellular signals received at the one of the plurality of locations based at least in part on the plurality of cellular signal data. The method further may include simulating the one or more individual cellular signals at the one of the plurality of locations in the environment based at least in part on the one or more cellular signal characteristics.

### INTRODUCTION

The present disclosure relates to systems and methods for characterizing radio frequency (RF) propagation conditions and determining cellular signal characteristics.

To increase occupant awareness and convenience, vehicles may be equipped with vehicle communication systems which are configured to transmit and receive cellular signals from cellular base stations. The performance of vehicle communication systems may be influenced by RF propagation conditions in the environment surrounding the vehicle. RF propagation conditions may vary greatly between different locations in an environment due to multiple factors. For example, RF propagation conditions in dense urban areas may be characterized by a low signal-to-noise ratio caused by electromagnetic interference. In another example, RF propagation conditions in rural or remote areas may be characterized by low signal strength and high latency due to long transmission distances. Current systems and methods for design, testing, and validation of vehicle communication systems may not account for the effects of varying RF propagation conditions and cellular signal characteristics at different locations throughout the environment.

Thus, while vehicle communication systems and methods achieve their intended purpose, there is a need for a new and improved system and method for characterizing radio frequency (RF) propagation conditions and determining RF characteristics for a vehicle.

### SUMMARY

According to several aspects, a method for determining cellular signal characteristics is provided. The method may include receiving and recording a plurality of cellular signal data at one of a plurality of locations in an environment. The plurality of cellular signal data includes cellular signals received at the one of the plurality of locations in the environment. The method further may include identifying one or more individual cellular signals received at the one of the plurality of locations based at least in part on the plurality of cellular signal data. The method further may include determining one or more cellular signal characteristics of each of the one or more individual cellular signals received at the one of the plurality of locations based at least in part on the plurality of cellular signal data. The method further may include simulating the one or more individual cellular signals at the one of the plurality of locations in the environment based at least in part on the one or more cellular signal characteristics of each of the one or more individual cellular signals received at the one of the plurality of locations.

In another aspect of the present disclosure, receiving and recording the plurality of cellular signal data further may include transiting the plurality of locations using a measurement vehicle. The measurement vehicle is equipped with a measurement antenna array and a global navigation satellite system (GNSS). Receiving and recording the plurality of cellular signal data further may include continuously receiving and recording the plurality of cellular signal data using the measurement antenna array. Receiving and recording the plurality of cellular signal data further may include continuously determining and recording a plurality of vehicle locations using the GNSS. Receiving and recording the plurality of cellular signal data further may include aligning a subset of the plurality of cellular signal data with each of the plurality of locations based at least in part on the plurality of vehicle locations.

In another aspect of the present disclosure, identifying the one or more individual cellular signals further may include determining a noise floor of the environment based at least in part on the plurality of cellular signal data. Identifying the one or more individual cellular signals further may include identifying one or more regions of interest in the environment having a higher energy than the noise floor using receive beamforming based at least in part on the plurality of cellular signal data. Identifying the one or more individual cellular signals further may include locating each of the one or more individual cellular signals within the one or more regions of interest using receive beamforming.

In another aspect of the present disclosure, identifying the one or more regions of interest further may include spatially sweeping the plurality of cellular signal data using a first beam having a first beam width to identify the one or more regions of interest.

In another aspect of the present disclosure, locating each of the one or more individual cellular signals further may include spatially sweeping each of the one or more regions of interest using a second beam having a second beam width to locate the one or more individual cellular signals. The second beam width is less than the first beam width.

In another aspect of the present disclosure, determining the one or more cellular signal characteristics of each of the one or more individual cellular signals further may include determining a direction of arrival of each of the one or more individual cellular signals. Determining the one or more cellular signal characteristics of each of the one or more individual cellular signals further may include determining an amplitude of each of the one or more individual cellular signals. Determining the one or more cellular signal characteristics of each of the one or more individual cellular signals further may include determining a phase of each of the one or more individual cellular signals. Determining the one or more cellular signal characteristics of each of the one or more individual cellular signals further may include determining a time of arrival of each of the one or more individual cellular signals.

In another aspect of the present disclosure, determining the one or more cellular signal characteristics of each of the one or more individual cellular signals further may include determining identifying metadata about each of the one or more individual cellular signals. The identifying metadata at least provides information about a base station which originated each of the one or more individual cellular signals.

In another aspect of the present disclosure, determining the identifying metadata further may include determining the identifying metadata about each of the one or more individual cellular signals. The identifying metadata includes at least one of: a cell identifier (cell ID), a system information block (SIB), a master information block (MIB), and a service set identifier (SSID).

In another aspect of the present disclosure, the method further may include identifying which of each of the one or more individual cellular signals are multipath signals based at least in part on the one or more cellular signal characteristics of each of the one or more individual cellular signals.

In another aspect of the present disclosure, simulating the one or more individual cellular signals further may include reproducing each of the one or more individual cellular signals in an anechoic chamber having a test vehicle.

According to several aspects, a system for determining cellular signal characteristics is provided. The system may include a measurement system including a measurement antenna array disposed on a measurement vehicle and a measurement controller in electrical communication with the measurement antenna array. The measurement controller is programmed to receive a plurality of cellular signal data using the measurement antenna array. The plurality of cellular signal data includes cellular signals received in an environment.

In another aspect of the present disclosure, the system further may include a test system including a test controller. The test controller is programmed to receive the plurality of cellular signal data from the measurement system. The test controller is further programmed to identify one or more regions of interest in the environment having a higher energy than a noise floor of the environment using receive beamforming based at least in part on the plurality of cellular signal data. The test controller is further programmed to locate each of one or more individual cellular signals within the one or more regions of interest using receive beamforming. The test controller is further programmed to determine one or more cellular signal characteristics of each of the one or more individual cellular signals based at least in part on the plurality of cellular signal data.

In another aspect of the present disclosure, to identify the one or more individual cellular signals, the test controller is further programmed to determine a noise floor of the environment based at least in part on the plurality of cellular signal data. To identify the one or more individual cellular signals, the test controller is further programmed to spatially sweep the plurality of cellular signal data using a first beam having a first beam width to identify one or more regions of interest in the environment having a higher energy than the noise floor using receive beamforming based at least in part on the plurality of cellular signal data. To identify the one or more individual cellular signals, the test controller is further programmed to spatially sweep each of the one or more regions of interest using a second beam having a second beam width to locate each of the one or more individual cellular signals within the one or more regions of interest using receive beamforming. The second beam width is less than the first beam width.

In another aspect of the present disclosure, to determine the one or more cellular signal characteristics of each of the one or more individual cellular signals, the test controller is further programmed to determine a direction of arrival of each of the one or more individual cellular signals. To determine the one or more cellular signal characteristics of each of the one or more individual cellular signals, the test controller is further programmed to determine an amplitude of each of the one or more individual cellular signals. To determine the one or more cellular signal characteristics of each of the one or more individual cellular signals, the test controller is further programmed to determine a phase of each of the one or more individual cellular signals. To determine the one or more cellular signal characteristics of each of the one or more individual cellular signals, the test controller is further programmed to determine a time of arrival of each of the one or more individual cellular signals.

In another aspect of the present disclosure, to determine the one or more cellular signal characteristics of each of the one or more individual cellular signals, the test controller is further programmed to determine identifying metadata about each of the one or more individual cellular signals. The identifying metadata at least provides information about a base station which originated each of the one or more individual cellular signals.

In another aspect of the present disclosure, to determine the identifying metadata, the test controller is further programmed to determine the identifying metadata about each of the one or more individual cellular signals. The identifying metadata includes at least one of: a cell identifier (cell ID), a system information block (SIB), a master information block (MIB), and a service set identifier (SSID).

In another aspect of the present disclosure, the test system further may include an anechoic chamber and one or more transmission antenna arrays in electrical communication with the test controller and disposed within the anechoic chamber. The test controller is further programmed to reproduce each of the one or more individual cellular signals in the anechoic chamber using the one or more transmission antenna arrays. A test vehicle is disposed within the anechoic chamber.

According to several aspects, a method for determining cellular signal characteristics is provided. The method may include transiting a plurality of locations in an environment using a measurement vehicle. The measurement vehicle is equipped with a measurement antenna array and a global navigation satellite system (GNSS). The method further may include continuously receiving and recording a plurality of cellular signal data using the measurement antenna array. The plurality of cellular signal data includes cellular signals received at the one of the plurality of locations in the environment. The method further may include continuously determining and recording a plurality of vehicle locations using the GNSS. The method further may include aligning a subset of the plurality of cellular signal data with each of the plurality of locations based at least in part on the plurality of vehicle locations. The method further may include identifying one or more individual cellular signals received at the one of the plurality of locations based at least in part on the plurality of cellular signal data. The method further may include determining one or more cellular signal characteristics of each of the one or more individual cellular signals received at the one of the plurality of locations based at least in part on the plurality of cellular signal data.

In another aspect of the present disclosure, identifying the one or more individual cellular signals further may include determining a noise floor of the environment based at least in part on the plurality of cellular signal data. Identifying the one or more individual cellular signals further may include spatially sweeping the plurality of cellular signal data using a first beam having a first beam width to identify one or more regions of interest in the environment having a higher energy than the noise floor using receive beamforming based at least in part on the plurality of cellular signal data. Identifying the one or more individual cellular signals further may include spatially sweeping each of the one or more regions of interest using a second beam having a second beam width to locate each of the one or more individual cellular signals within the one or more regions of interest using receive beamforming.

In another aspect of the present disclosure, determining the one or more cellular signal characteristics of each of the one or more individual cellular signals further may include determining a direction of arrival of each of the one or more individual cellular signals. Determining the one or more cellular signal characteristics of each of the one or more individual cellular signals further may include determining an amplitude of each of the one or more individual cellular signals. Determining the one or more cellular signal characteristics of each of the one or more individual cellular signals further may include determining a phase of each of the one or more individual cellular signals. Determining the one or more cellular signal characteristics of each of the one or more individual cellular signals further may include determining a time of arrival of each of the one or more individual cellular signals. Determining the one or more cellular signal characteristics of each of the one or more individual cellular signals further may include determining identifying metadata about each of the one or more individual cellular signals. The identifying metadata at least provides information about a base station which originated each of the one or more individual cellular signals.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is schematic diagram of a measurement system for measuring cellular signals, according to an exemplary embodiment;

FIG. 2 is a schematic diagram of a test system for testing a test vehicle, according to an exemplary embodiment; and

FIG. 3 is a flowchart of a method for determining cellular signal characteristics, according to an exemplary embodiment.

### DETAILED DESCRIPTION

The following description is merely exemplary in nature and is not intended to limit the present disclosure, application, or uses.

In aspects of the present disclosure, radio frequency (RF) propagation conditions may vary greatly between different locations in an environment due to multiple factors. For example, RF propagation conditions in dense urban areas may be characterized by many reflections and multipath signals caused by obstructions in the environment (e.g., large buildings). In another example, RF propagation conditions in rural or remote areas may be characterized by low signal strength and high latency due to long transmission distances. The present disclosure provides a new and improved system and method to measure and record RF propagation conditions in various diverse environments such that realistic RF propagation conditions may be recreated in a controlled setting for testing and development of wireless systems.

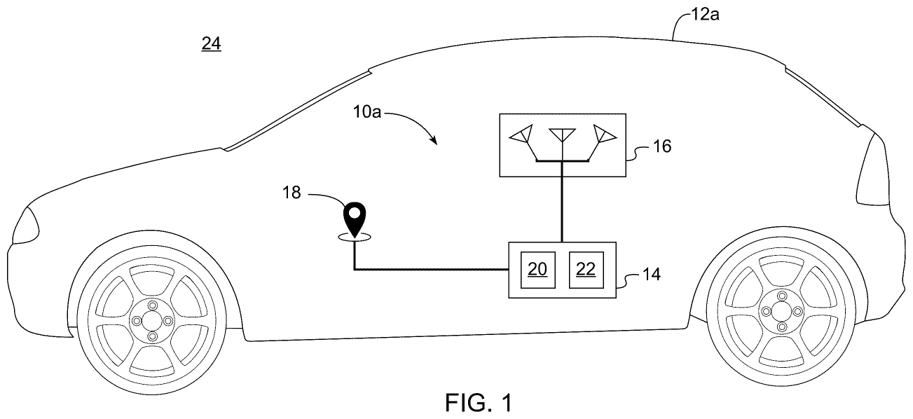

Referring to FIG. 1, a measurement system for measuring cellular signals is illustrated and generally indicated by reference number 10a. The measurement system 10a is shown with a measurement vehicle 12a. While a passenger vehicle is illustrated, it should be appreciated that the measurement vehicle 12a may be any type of vehicle without departing from the scope of the present disclosure. The measurement system 10a generally includes a measurement controller 14, a measurement antenna array 16, and a global navigation satellite system (GNSS) 18.

The measurement controller 14 is used to implement a method 100 for determining cellular signal characteristics, as will be described below. The measurement controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the measurement controller 14, a semiconductor-based microprocessor (in the form of a microchip or chip set), a macroprocessor, a combination thereof, or generally a device for executing instructions.

The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the measurement controller 14 to control various systems of the measurement vehicle 12a.

The measurement controller 14 may also consist of multiple controllers which are in electrical communication with each other. The measurement controller 14 may be inter-connected with additional systems and/or controllers of the measurement vehicle 12a, allowing the measurement controller 14 to access data such as, for example, speed, acceleration, braking, and steering angle of the measurement vehicle 12a.

The measurement controller 14 is in electrical communication with the measurement antenna array 16 and the GNSS 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the measurement controller 14 are within the scope of the present disclosure. It should further be understood that, in the scope of the present disclosure, electrical communication also includes power and/or energy transfer between electrical devices (e.g., using conducting wires and/or wireless power transmission techniques).

The measurement antenna array 16 is used to receive radiofrequency (RF) signals from an environment 24 surrounding the measurement vehicle 12a. In a non-limiting example, the measurement antenna array 16 is configured to receive cellular network signals, such as, for example, 2G signals, 3G signals, 4G signals, 5G signals, 6G signals, and/or the like. In an exemplary embodiment, the measurement antenna array 16 includes a plurality of antenna elements of different types, designs, and/or functional principles. In a non-limiting example, the measurement antenna array 16 includes one or more monopole antennas. In another non-limiting example, the measurement antenna array 16 includes one or more dipole antennas. It should be understood that the measurement antenna array 16 may include any quantity, type, and/or configuration of antennas without departing from the scope of the present disclosure. It should further be understood that the measurement antenna array 16 may further include additional signal processing components in electrical communication with the plurality of antenna elements, such as, for example, filters, amplifiers, receiver modules, and/or the like.

In an exemplary embodiment, the measurement antenna array 16 is disposed on an outside surface of the measurement vehicle 12a, for example, on a roof, trunk, door, and/or window of the measurement vehicle 12a. In another exemplary embodiment, the measurement antenna array 16 is disposed on an inside surface of the measurement vehicle 12a, for example, on a headliner, dashboard, door, and/or window of the measurement vehicle 12a. In some examples, the measurement antenna array 16 is temporarily affixed to the measurement vehicle 12a. In an exemplary embodiment, the measurement antenna array 16 is configured with omnidirectional reception capability to receive signals from all directions relative to the measurement vehicle 12a. In a non-limiting example, the measurement controller 14 is configured to simultaneously sample each of the plurality of antenna elements of the measurement antenna array 16 and store the RF signal data received by the measurement antenna array 16 for further processing as will be discussed in greater detail below. The measurement antenna array 16 is in electrical communication with the measurement controller 14 as discussed above.

The GNSS 18 is used to determine a geographical location of the measurement vehicle 12a. In an exemplary embodiment, the GNSS 18 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the measurement vehicle 12a based on the signals received by the GPS receiver antenna. In an exemplary embodiment, the GNSS 18 additionally includes a map. The map includes information about infrastructure such as municipality borders, roadways, railways, sidewalks, buildings, and the like. Therefore, the geographical location of the measurement vehicle 12a is contextualized using the map information. In a non-limiting example, the map is retrieved from a remote source using a wireless connection. In another non-limiting example, the map is stored in a database of the GNSS 18. It should be understood that various additional types of satellite-based radionavigation systems, such as, for example, the Global Positioning System (GPS), Galileo, GLONASS, and the BeiDou Navigation Satellite System (BDS) are within the scope of the present disclosure. The GNSS 18 is in electrical communication with the measurement controller 14 as discussed above.

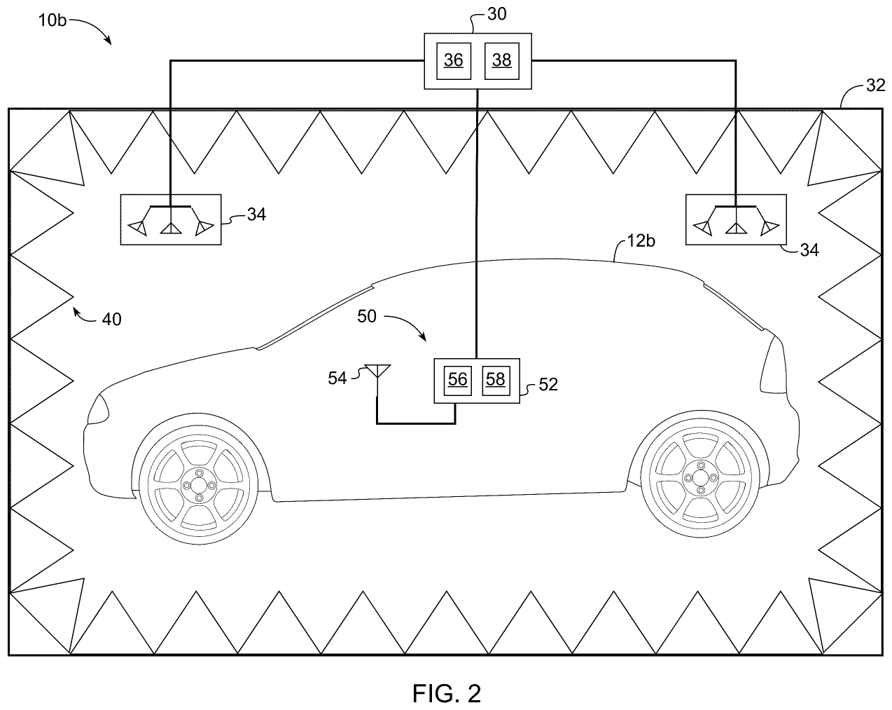

Referring to FIG. 2, a test system for testing a test vehicle 12b is illustrated and generally indicated by reference number 10b. The test system 10b is shown with a test vehicle 12b. While a passenger vehicle is illustrated, it should be appreciated that the test vehicle 12b may be any type of vehicle without departing from the scope of the present disclosure. The test system 10b generally includes a test controller 30, an anechoic chamber 32, and one or more transmission antenna arrays 34.

The test controller 30 is used to implement the method 100 for determining cellular signal characteristics, as will be described below. The test controller 30 includes at least one processor 36 and a non-transitory computer readable storage device or media 38. The processor 36 may be a custom made or commercially available processor, a central processing unit (CPU), a graphics processing unit (GPU), an auxiliary processor among several processors associated with the test controller 30, a semiconductor-based microprocessor (in the form of a microchip or chip set), a macroprocessor, a combination thereof, or generally a device for executing instructions.

The computer readable storage device or media 38 may include volatile and nonvolatile storage in read-only memory (ROM), random-access memory (RAM), and keep-alive memory (KAM), for example. KAM is a persistent or non-volatile memory that may be used to store various operating variables while the processor 36 is powered down. The computer-readable storage device or media 38 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions.

The test controller 30 may also consist of multiple controllers which are in electrical communication with each other. The test controller 30 is in electrical communication with the one or more transmission antenna arrays 34. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the test controller 30 are within the scope of the present disclosure. It should further be understood that, in the scope of the present disclosure, electrical communication also includes power and/or energy transfer between electrical devices (e.g., using conducting wires and/or wireless power transmission techniques).

The anechoic chamber 32 is used to provide a controlled RF environment for testing the test vehicle 12b. In an exemplary embodiment, the anechoic chamber 32 is an RF anechoic chamber coated with radiation absorbent material (RAM) 40. The RAM 40 is configured to effectively absorb incident RF radiation to mitigate and/or eliminate reflection of RF signals within the anechoic chamber 32. In a non-limiting example, the RAM 40 includes pyramid-shaped urethane foam blocks loaded with conductive carbon material. In some examples, the anechoic chamber 32 further includes a Faraday cage (not shown) to mitigate the intrusion of environmental RF noise into the anechoic chamber 32.

The one or more transmission antenna arrays 34 are used to produce RF signals within the anechoic chamber 32 for testing the test vehicle 12b. In an exemplary embodiment, at least one of the one or more transmission antenna arrays 34 is a phased array including a plurality of antenna elements producing a beam of radio waves which may be electronically steered (i.e., beamforming) without physical movement of the one or more transmission antenna arrays 34. In another exemplary embodiment, at least one of the one or more transmission antenna arrays 34 includes a directional or omnidirectional antenna element having an actuator allowing physical movement or aiming of the antenna element. In a non-limiting example, the one or more transmission antenna arrays 34 are configured to be controlled by the test controller 30 to produce any arbitrary RF environment within the anechoic chamber 32, including, for example, signals effectively originating from any location within the anechoic chamber 32.

In an exemplary embodiment, the one or more transmission antenna arrays 34 are disposed within the anechoic chamber 32. In another exemplary embodiment, the one or more transmission antenna arrays 34 are disposed outside of the anechoic chamber 32 and inject RF signals into the anechoic chamber 32 using waveguides. While FIG. 2 shows two transmission antenna arrays 34, it should be understood that the test system 10b may include any quantity of transmission antenna arrays 34 disposed within the anechoic chamber 32. In a non-limiting example, the test system 10b includes transmission antenna arrays 34 disposed at multiple elevations within the anechoic chamber 32 (e.g., one transmission antenna array 34 in each of six corners of a rectangular chamber). The one or more transmission antenna arrays 34 are in electrical communication with the test controller 30 as discussed above.

With continued reference to FIG. 2, the test vehicle 12b has a test vehicle system 50. In an exemplary embodiment, the test vehicle system 50 includes a test vehicle controller 52 and a test vehicle communication system 54.

The test vehicle controller 52 is used to control the test vehicle communication system 54, as will be described below. The test vehicle controller 52 includes at least one processor 56 and a non-transitory computer readable storage device or media 58. The processor 56 may be a custom made or commercially available processor, a central processing unit (CPU), a graphics processing unit (GPU), an auxiliary processor among several processors associated with the test vehicle controller 52, a semiconductor-based microprocessor (in the form of a microchip or chip set), a macroprocessor, a combination thereof, or generally a device for executing instructions.

The computer readable storage device or media 58 may include volatile and nonvolatile storage in read-only memory (ROM), random-access memory (RAM), and keep-alive memory (KAM), for example. KAM is a persistent or non-volatile memory that may be used to store various operating variables while the processor 56 is powered down. The computer-readable storage device or media 58 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the test vehicle controller 52 to control various systems of the test vehicle 12b.

The test vehicle controller 52 may also consist of multiple controllers which are in electrical communication with each other. The test vehicle controller 52 may be inter-connected with additional systems and/or controllers of the test vehicle 12b, allowing the test vehicle controller 52 to access data such as, for example, speed, acceleration, braking, and steering angle of the test vehicle 12b.

The test vehicle controller 52 is in electrical communication with the test vehicle communication system 54. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the test vehicle controller 52 are within the scope of the present disclosure. It should further be understood that, in the scope of the present disclosure, electrical communication also includes power and/or energy transfer between electrical devices (e.g., using conducting wires and/or wireless power transmission techniques).

The test vehicle communication system 54 is used by the test vehicle controller 52 to communicate with other systems external to the test vehicle 12b. For example, the test vehicle communication system 54 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the test vehicle 12b and any remote system (e.g., vehicles, infrastructure, and/or remote systems).

In certain embodiments, the test vehicle communication system 54 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the test vehicle communication system 54 may further include an embedded universal integrated circuit card (eUICC) configured to store at least one cellular connectivity configuration profile, for example, an embedded subscriber identity module (eSIM) profile.

The test vehicle communication system 54 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the test vehicle communication system 54 may include one or more antennas and/or communication transceivers for receiving and/or transmitting signals, such as cooperative sensing messages (CSMs). The test vehicle communication system 54 is configured to wirelessly communicate information between the test vehicle 12b and another vehicle. Further, the test vehicle communication system 54 is configured to wirelessly communicate information between the test vehicle 12b and infrastructure or other vehicles. It should be understood that the test vehicle communication system 54 may be integrated with the test vehicle controller 52 (e.g., on a same circuit board with the test vehicle controller 52 or otherwise a part of the test vehicle controller 52) without departing from the scope of the present disclosure.

In an exemplary embodiment, the test vehicle controller 52 is configured to use the test vehicle communication system 54 receive signals transmitted by the one or more transmission antenna arrays 34. In a non-limiting example, the test vehicle controller 52 evaluates signal characteristics such as, for example, signal strength, signal-to-noise ratio, and/or the like. The test vehicle controller 52 further evaluates connection characteristics such as, for example, transfer speed/bandwidth, latency, and/or the like. In an exemplary embodiment, the test vehicle controller 52 is in electrical communication with the test controller 30 to transfer the signal characteristics, the connection characteristics, and/or additional signal measurement data to the test controller 30 for further analysis.

It should be understood that the test vehicle 12b and the test vehicle system 50 are merely exemplary in nature, and that the system 10b may be used to test any device capable of wireless communication, including, for example, mobile devices (e.g., smartphones), aircraft, watercraft, spacecraft, and/or the like.

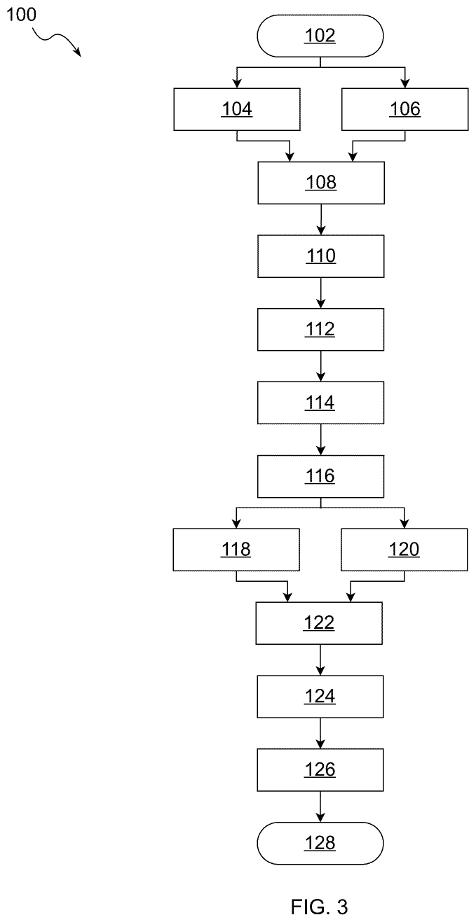

Referring to FIG. 3, a flowchart of the method 100 for determining cellular signal characteristics is shown. Collectively, the measurement system 10a and the test system 10b are referred to as a system for determining cellular signal characteristics. The system for determining cellular signal characteristics is used to execute the method 100 for determining cellular signal characteristics. The method 100 begins at block 102 and proceeds to blocks 104 and 106. At block 104, the measurement controller 14 uses the measurement antenna array 16 to continuously receive a plurality of cellular signal data while the measurement vehicle 12a transits (i.e., moves through) the environment 24. In the scope of the present disclosure, the plurality of cellular signal data includes all cellular signals in the environment 24 received by the measurement antenna array 16. In a non-limiting example, the measurement controller 14 records the plurality of cellular signal data along with a reception timestamp for each of the plurality of cellular signal data in the media 22 of the measurement controller 14. It should be understood that the system 10 and method 100 of the present disclosure may be used to determine signal characteristics of other RF signals including, for example, wireless local area network (WLAN) signals, personal area network (e.g., BLUETOOTH) signals, near-field communication (NFC) signals, and/or the like. Signal characteristics of other RF signals may be generally referred to as RF signal characteristics. After block 104, the method 100 proceeds to block 108, as will be discussed in greater detail below.

At block 106, the measurement controller 14 uses the GNSS 18 to continuously determine a plurality of vehicle locations while the measurement vehicle 12a transits the environment 24. In a non-limiting example, the measurement controller 14 records the plurality of vehicle locations along with a location timestamp for each of the plurality of vehicle locations in the media 22 of the measurement controller 14. After block 106, the method 100 proceeds to block 108.

At block 108, the measurement controller 14 aligns a subset of the plurality of cellular signal data with each of a plurality of locations in the environment 24. In an exemplary embodiment, the measurement controller 14 uses the reception timestamp of each of the plurality of cellular signal data and the location timestamp for each of the plurality of vehicle locations to spatially align the plurality of cellular signal data. For example, the result of block 108 is that at each of the plurality of locations in the environment 24 (e.g., locations spaced every fifty meters along a particular roadway), all cellular signals in the environment 24 received by the measurement antenna array 16 are known. In a non-limiting example, the alignment data is stored in the form of a database in the media 22 of the measurement controller 14. After block 108, the method 100 proceeds to block 110.

At block 110, the location-aligned cellular signal data determined at block 108 is transferred to the test controller 30. In an exemplary embodiment, the location-aligned cellular signal data is transferred using the internet and wireless and/or wired communication. In another exemplary embodiment, the location-aligned cellular signal data is transferred directly from the measurement controller 14 to the test controller 30 using wireless and/or wired peer-to-peer communication. It should be understood that the location-aligned cellular signal data may first be transferred to an intermediate system (e.g., a desktop computer, a server system, and/or the like) for additional backup, storage, and/or post-processing before transmission to the test controller 30 without departing from the scope of the present disclosure. After block 110, the method 100 proceeds to block 112.

At block 112, the test controller 30 determines a noise floor of each of the plurality of locations in the environment 24 based at least in part on the plurality of location-aligned cellular signal data received at block 110. In the scope of the present disclosure, the noise floor is a measure of signals received other than cellular signals (e.g., thermal noise, atmospheric noise, other, non-cellular RF signals, and/or the like). In an exemplary embodiment, the test controller 30 determines the noise floor by identifying a minimum received signal magnitude at each of the plurality of locations in the environment 24. After block 112, the method 100 proceeds to block 114.

At block 114, the test controller 30 identifies one or more regions of interest at each of the plurality of locations in the environment 24. In the scope of the present disclosure, a region of interest is a region of the environment 24 from which a cellular signal is approaching the measurement vehicle 12a. In a non-limiting example, a region of interest at any given location of the plurality of locations is defined as a region of the environment 24 having a higher received RF energy than the noise floor at the given location of the plurality of locations determined at block 112. In an exemplary embodiment, to identify the one or more regions of interest at each of the plurality of locations, the test controller 30 uses receive beamforming.

In an exemplary embodiment, receive beamforming means that the test controller 30 applies a set of weighted coefficients to the signals received by each antenna element in the measurement antenna array 16 to generate a first virtual reception beam. Cellular signals having an azimuth angle of arrival and zenith angle of arrival falling within the first virtual reception beam are detected by the first virtual reception beam. By adjusting the set of weighted coefficients, the test controller 30 moves the first virtual reception beam (i.e., adjusts an azimuth angle and zenith angle of a center of the first virtual reception beam relative to the measurement vehicle 12a) to spatially sweep the plurality of cellular signal data. In a non-limiting example, the first virtual reception beam has a first beam width (e.g., three meters).

In a non-limiting example, the test controller 30 uses receive beamforming with the first virtual reception beam to sweep in all directions around the measurement vehicle 12a at each of the plurality of locations and identify the one or more regions of interest (e.g., defined as one or more azimuth angle and zenith angle ranges) at each of the plurality of locations. After block 114, the method 100 proceeds to block 116.

At block 116, the test controller 30 locates each of one or more individual cellular signals at each of the plurality of locations in the environment 24. In the scope of the present disclosure, an individual cellular signal is a distinct RF transmission originating from a specific cellular device (e.g., a smartphone) or a specific cellular base station (i.e., a cell tower). For example, an individual cellular signal may include a broadcast control channel signal, a synchronization signal, a reference signal, and/or the like. In an exemplary embodiment, to locate each of one or more individual cellular signals, the test controller 30 uses receive beamforming.

In an exemplary embodiment, the test controller 30 applies a set of weighted coefficients to the signals received by each antenna element in the measurement antenna array 16 to generate a second virtual reception beam. Cellular signals having an azimuth angle of arrival and zenith angle of arrival falling within the second virtual reception beam are detected by the second virtual reception beam. By adjusting the set of weighted coefficients, the test controller 30 moves the second virtual reception beam (i.e., adjusts an azimuth angle and zenith angle of a center of the second virtual reception beam relative to the measurement vehicle 12a) to spatially sweep the plurality of cellular signal data. In a non-limiting example, the second virtual reception beam has a second beam width (e.g., ten centimeters) which is less than the first beam width.

In a non-limiting example, the test controller 30 uses receive beamforming with the second virtual reception beam to sweep within each of the one or more regions of interest at each of the plurality of locations determined at block 114. In an exemplary embodiment, the test controller 30 decodes received data to identify the one or more individual cellular signals. For example, the test controller 30 may distinguish between the one or more individual cellular signals based on network identifying information contained in each of the one or more individual cellular signals (e.g., cell ID). In another example, the test controller 30 may distinguish between the one or more individual cellular signals based on additional signal characteristics including, for example, frequency band, channel number, and/or the like.

In an exemplary embodiment, the test controller 30 records the data transmitted by each of the one or more individual cellular signals and the azimuth angle of arrival and zenith angle of arrival of each of the one or more individual cellular signals in the media 38 of the test controller 30. After block 116, the method 100 proceeds to blocks 118 and 120.

At block 118, the test controller 30 determines one or more physical cellular signal characteristics of each of the one or more individual cellular signals at each of the plurality of locations. In an exemplary embodiment, the one or more physical cellular signal characteristics includes at least one of: a direction of arrival of each of the one or more individual cellular signals (i.e., the azimuth angle of arrival and zenith angle of arrival of each of the one or more individual cellular signals), an amplitude of each of the one or more individual cellular signals, a phase of each of the one or more individual cellular signals, a signal strength of each of the one or more individual cellular signals, a signal-to-noise ratio of each of the one or more individual cellular signals, and/or a time of arrival of each of the one or more individual cellular signals. In a non-limiting example, the test controller 30 determines the one or more physical cellular signal characteristics of each of the one or more individual cellular signals by performing signal processing on each of the one or more individual cellular signals. After block 118, the method 100 proceeds to block 122 as will be discussed in greater detail below.

At block 120, the test controller 30 determines identifying metadata about each of the one or more individual cellular signals at each of the plurality of locations. In an exemplary embodiment, the identifying metadata at least provides information about a base station which originated each of the one or more individual cellular signals. In another exemplary embodiment, the identifying metadata further includes at least one of: a cell identifier (cell ID), a system information block (SIB), a master information block (MIB), and/or a service set identifier (SSID). In a non-limiting example, the test controller 30 determines the identifying metadata about each of the one or more individual cellular signals by decoding each of the one or more individual cellular signals and extracting identifying information from each of the one or more individual cellular signals. After block 120, the method 100 proceeds to block 122.

At block 122, the test controller 30 determines additional relevant information about each of the one or more individual cellular signals at each of the plurality of locations. In an exemplary embodiment, the test controller 30 identifies which, if any, of each of the one or more individual cellular signals are multipath signals (i.e., signals which have been reflected) and which, if any, of each of the one or more individual cellular signals are direct signals (i.e., signals received directly from a base station without reflection). In a non-limiting example, the test controller 30 identifies the multipath vs. direct signals based at least in part on the one or more physical cellular signal characteristics of each of the one or more individual cellular signals determined at block 118 and/or the identifying metadata about each of the one or more individual cellular signals determined at block 120. In a non-limiting example, to identify the multipath vs. direct signals, the test controller 30 identifies signals originating from a same base station based on the identifying metadata and distinguishes between direct and multipath signals based on the one or more physical cellular signal characteristics (e.g., time of arrival). After block 122, the method 100 proceeds to block 124.

At block 124, the test controller 30 uses the one or more transmission antenna arrays 34 to reproduce each of the one or more individual cellular signals at each of the plurality of locations within the anechoic chamber 32 having the test vehicle 12b. In an exemplary embodiment, the test controller 30 uses the one or more transmission antenna arrays 34 to produce signals having at least the same physical cellular signal characteristics as each of the one or more individual cellular signals determined at block 118. In another exemplary embodiment, the test controller 30 uses the one or more transmission antenna arrays 34 to produce signals having at least the same identifying metadata as each of the one or more individual cellular signals determined at block 120.

In an exemplary embodiment, the test controller 30 reproduces each of the one or more individual cellular signals at each of the plurality of locations in sequence to simulate driving the test vehicle 12b through the environment 24 through each of the plurality of locations. After block 124, the method 100 proceeds to block 126.

At block 126, the test vehicle controller 52 uses the test vehicle communication system 54 to receive the signals transmitted by the one or more transmission antenna arrays 34 at block 124. In an exemplary embodiment, the test vehicle controller 52 records signal quality information such as, for example, received signal strength, signal-to-noise ratio, and/or the like. In a non-limiting example, the test vehicle controller 52 communicates the signal quality information to the test controller 30 for data processing and aggregation. In an exemplary embodiment, the data gathered by performing blocks 124 and 126 is used to optimize the design, orientation, size, and/or placement of the test vehicle communication system 54 for the test vehicle 12b to maximize performance of the test vehicle communication system 54. After block 126, the method 100 proceeds to enter a standby state at block 128.

In an exemplary embodiment, the method 100 repeatedly exits the standby state 128 and restarts at block 102. In a non-limiting example, the method 100 exits the standby state 128 and restarts on a timer, for example, every three hundred milliseconds.

The systems 10a, 10b and method 100 of the present disclosure offer several advantages. Using the measurement system 10a, real-world cellular signal data may be gathered for various different environments (e.g., city, suburban, rural, remote), in various different environmental conditions (e.g., weather conditions), and in various different locations around the world. Using the measurement antenna array 16 to continuously receive all signals in the environment 24 allows the measurement vehicle 12a to transit the environment at a normal speed without impeding the flow of traffic. Performing receive beamforming in post-processing using the test system 10b allows the data gathered by the measurement system 10a to be analyzed and individual cellular signals to be isolated and characterized without the need for real-time processing capabilities on the measurement vehicle 12a. Use of the test system 10b with the anechoic chamber 32 allows for simulation of diverse RF environments, enabling rapid testing of the test vehicle 12b or other devices under test (DUT) under a wide range of operating conditions which reflect measured real-world conditions.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for determining cellular signal characteristics, the method comprising:
receiving and recording a plurality of cellular signal data at one of a plurality of locations in an environment, wherein the plurality of cellular signal data includes cellular signals received at the one of the plurality of locations in the environment;
identifying one or more individual cellular signals received at the one of the plurality of locations based at least in part on the plurality of cellular signal data;
determining one or more cellular signal characteristics of each of the one or more individual cellular signals received at the one of the plurality of locations based at least in part on the plurality of cellular signal data; and
simulating the one or more individual cellular signals at the one of the plurality of locations in the environment based at least in part on the one or more cellular signal characteristics of each of the one or more individual cellular signals received at the one of the plurality of locations.

2. The method of claim 1, wherein receiving and recording the plurality of cellular signal data further comprises:
transiting the plurality of locations using a measurement vehicle, wherein the measurement vehicle is equipped with a measurement antenna array and a global navigation satellite system (GNSS);
continuously receiving and recording the plurality of cellular signal data using the measurement antenna array;
continuously determining and recording a plurality of vehicle locations using the GNSS; and
aligning a subset of the plurality of cellular signal data with each of the plurality of locations based at least in part on the plurality of vehicle locations.

3. The method of claim 1, wherein identifying the one or more individual cellular signals further comprises:
determining a noise floor of the environment based at least in part on the plurality of cellular signal data;
identifying one or more regions of interest in the environment having a higher energy than the noise floor using receive beamforming based at least in part on the plurality of cellular signal data; and
locating each of the one or more individual cellular signals within the one or more regions of interest using receive beamforming.

4. The method of claim 3, wherein identifying the one or more regions of interest further comprises:
spatially sweeping the plurality of cellular signal data using a first beam having a first beam width to identify the one or more regions of interest.

5. The method of claim 4, wherein locating each of the one or more individual cellular signals further comprises:
spatially sweeping each of the one or more regions of interest using a second beam having a second beam width to locate the one or more individual cellular signals, wherein the second beam width is less than the first beam width.

6. The method of claim 1, wherein determining the one or more cellular signal characteristics of each of the one or more individual cellular signals further comprises:
determining a direction of arrival of each of the one or more individual cellular signals;
determining an amplitude of each of the one or more individual cellular signals;
determining a phase of each of the one or more individual cellular signals; and
determining a time of arrival of each of the one or more individual cellular signals.

7. The method of claim 6, wherein determining the one or more cellular signal characteristics of each of the one or more individual cellular signals further comprises:
determining identifying metadata about each of the one or more individual cellular signals, wherein the identifying metadata at least provides information about a base station which originated each of the one or more individual cellular signals.

8. The method of claim 7, wherein determining the identifying metadata further comprises:
determining the identifying metadata about each of the one or more individual cellular signals, wherein the identifying metadata includes at least one of: a cell identifier (cell ID), a system information block (SIB), a master information block (MIB), and a service set identifier (SSID).

9. The method of claim 7 further comprising:
identifying which of each of the one or more individual cellular signals are multipath signals based at least in part on the one or more cellular signal characteristics of each of the one or more individual cellular signals.

10. The method of claim 1, wherein simulating the one or more individual cellular signals further comprises:
reproducing each of the one or more individual cellular signals in an anechoic chamber having a test vehicle.

11. A system for determining cellular signal characteristics, the system comprising:
a measurement system including:
a measurement antenna array disposed on a measurement vehicle; and
a measurement controller in electrical communication with the measurement antenna array, wherein the measurement controller is programmed to:
receive a plurality of cellular signal data using the measurement antenna array, wherein the plurality of cellular signal data includes cellular signals received in an environment.

12. The system of claim 11, further comprising:
a test system including:
a test controller, wherein the test controller is programmed to:
receive the plurality of cellular signal data from the measurement system;
identify one or more regions of interest in the environment having a higher energy than a noise floor of the environment using receive beamforming based at least in part on the plurality of cellular signal data;
locate each of one or more individual cellular signals within the one or more regions of interest using receive beamforming; and
determine one or more cellular signal characteristics of each of the one or more individual cellular signals based at least in part on the plurality of cellular signal data.

13. The system of claim 12, wherein to identify the one or more individual cellular signals, the test controller is further programmed to:
determine a noise floor of the environment based at least in part on the plurality of cellular signal data;
spatially sweep the plurality of cellular signal data using a first beam having a first beam width to identify one or more regions of interest in the environment having a higher energy than the noise floor using receive beamforming based at least in part on the plurality of cellular signal data; and
spatially sweep each of the one or more regions of interest using a second beam having a second beam width to locate each of the one or more individual cellular signals within the one or more regions of interest using receive beamforming, wherein the second beam width is less than the first beam width.

14. The system of claim 13, wherein to determine the one or more cellular signal characteristics of each of the one or more individual cellular signals, the test controller is further programmed to:
determine a direction of arrival of each of the one or more individual cellular signals;
determine an amplitude of each of the one or more individual cellular signals;
determine a phase of each of the one or more individual cellular signals;
determine a time of arrival of each of the one or more individual cellular signals.

15. The system of claim 14, wherein to determine the one or more cellular signal characteristics of each of the one or more individual cellular signals, the test controller is further programmed to:
determine identifying metadata about each of the one or more individual cellular signals, wherein the identifying metadata at least provides information about a base station which originated each of the one or more individual cellular signals.

16. The system of claim 15, wherein to determine the identifying metadata, the test controller is further programmed to:
determine the identifying metadata about each of the one or more individual cellular signals, wherein the identifying metadata includes at least one of: a cell identifier (cell ID), a system information block (SIB), a master information block (MIB), and a service set identifier (SSID).

17. The system of claim 16, the test system further including an anechoic chamber and one or more transmission antenna arrays in electrical communication with the test controller and disposed within the anechoic chamber, and wherein the test controller is further programmed to:
reproduce each of the one or more individual cellular signals in the anechoic chamber using the one or more transmission antenna arrays, wherein a test vehicle is disposed within the anechoic chamber.

18. A method for determining cellular signal characteristics, the method comprising:
transiting a plurality of locations in an environment using a measurement vehicle, wherein the measurement vehicle is equipped with a measurement antenna array and a global navigation satellite system (GNSS);
continuously receiving and recording a plurality of cellular signal data using the measurement antenna array, wherein the plurality of cellular signal data includes cellular signals received at the one of the plurality of locations in the environment;
continuously determining and recording a plurality of vehicle locations using the GNSS;
aligning a subset of the plurality of cellular signal data with each of the plurality of locations based at least in part on the plurality of vehicle locations;
identifying one or more individual cellular signals received at the one of the plurality of locations based at least in part on the plurality of cellular signal data; and
determining one or more cellular signal characteristics of each of the one or more individual cellular signals received at the one of the plurality of locations based at least in part on the plurality of cellular signal data.

19. The method of claim 18, wherein identifying the one or more individual cellular signals further comprises:
determining a noise floor of the environment based at least in part on the plurality of cellular signal data;
spatially sweeping the plurality of cellular signal data using a first beam having a first beam width to identify one or more regions of interest in the environment having a higher energy than the noise floor using receive beamforming based at least in part on the plurality of cellular signal data; and
spatially sweeping each of the one or more regions of interest using a second beam having a second beam width to locate each of the one or more individual cellular signals within the one or more regions of interest using receive beamforming.

20. The method of claim 19, wherein determining the one or more cellular signal characteristics of each of the one or more individual cellular signals further comprises:
determining a direction of arrival of each of the one or more individual cellular signals;
determining an amplitude of each of the one or more individual cellular signals;
determining a phase of each of the one or more individual cellular signals;
determining a time of arrival of each of the one or more individual cellular signals; and
determining identifying metadata about each of the one or more individual cellular signals, wherein the identifying metadata at least provides information about a base station which originated each of the one or more individual cellular signals.
